(19) United States
(12) Patent Application Publication
(10) Pub. No.: US 2012/0180584 A1
(43) Pub. Date: Jul. 19, 2012

(54) Pivotal drive

(75) Inventor: Uwe Weiss, Buchen-Bodigheim (DE)

(73) Assignee: Weiss GmbH Sondermaschinentechnik, Buchen (Odw) (DE)

(21) Appl. No.: 13/006,199

(22) Filed: Jan. 13, 2011

(51) Int. Cl. F16H 25/16

(52) U.S. Cl. 74/55; 74/25

(57) ABSTRACT

The invention relates to a pivotal drive, in particular a round indexing table having a plate which can be driven by a motor to execute a rotary movement about an axis of rotation and having a bearing arrangement for the journaling of the plate in a housing of the pivotal drive, the bearing arrangement including at least one radial bearing and at least a first axial bearing and a second axial bearing. The radial bearing cooperates with a radial bearing surface formed by an outer peripheral surface of the plate. The first axial bearing cooperates with a first bearing surface of the plate and the second axial bearing cooperates with a second bearing surface of the plate and the bearing surfaces are arranged displaced parallel to one another with respect to the axis of rotation of the plate.

The present invention relates to a pivotal drive, in particular to a rotary indexing table having a plate which can be driven by a motor to execute a rotary movement about an axis of rotation and having a bearing arrangement for the journaling of the plate in a housing of the pivotal drive.

Such pivotal drives find extensive use amongst other things in assembly and/or automation technology. Workpieces can for example be arranged on the plate which have to be given an indexed or continuous rotary movement for their machining and/or assembly.

An important requirement for such pivotal drives is a high precision of the rotary movement even with high loading. I.e. the plate or the workpieces arranged on it should always have a well-defined position/orientation relative to the assembly tools/machining tools. The loading of the plate and also of the bearing arrangement associated with it is very high, in particular with heavy workpieces so that deformations and permanent damage of the components of the pivotal drive can arise. This leads to imprecision in the rotary movement of the table.

It is thus an object of the present invention to provide a pivotal drive of the initially named kind which withstands high loadings and nevertheless operates precisely. In the same time it should be of simple design and also constructed at favorable cost.

This object is satisfied by a pivotal drive having the features of claim 1.

The pivotal drive of the invention of the initially named kind has a bearing arrangement which includes at least one radial bearing and at least a first axial bearing and a second axial bearing. The radial bearing cooperates with a radial bearing surface formed by an outer peripheral surface of the plate, while the first axial bearing cooperates with a first bearing surface of the plate and the second axial bearing with a second bearing surface of the plate. The bearing surfaces are arranged displaced in parallel to one another with respect to the axis of rotation of the plate.

In other words a radial journaling of the plate does not take place at a surface of the plate which faces the rotary axis but rather at an external peripheral surface of the plate. The diameter of the radial bearing can be selected to be larger. For a loading of the same size the radial bearing in the pivotal drive of the invention is thus loaded less heavily than in customary pivotal drives having an inwardly facing radial bearing surface. Moreover, load components operating in the axial direction can be taken up in an efficient way and means through the two axial bearings. Through the choice of a displaced arrangement of the bearing surfaces of the axial bearings a particularly compact construction can moreover be realized. This applies in particular when the bearing surfaces overlap at least in part, or in particular completely, when viewed in the direction of the axis of rotation. With a complete overlap the radial spacing of the two bearing surfaces from the axis of rotation is the same.

The first bearing surface and the second bearing surface can extend substantially perpendicular to the axis of rotation, with the first bearing surface facing towards a surface of the plate and with the second bearing surface facing away from the surface of the plate. In other words, the first and the second bearing surfaces are arranged at opposite axial side surfaces of the plate. In this way tilting moments acting for example on the plate can be better taken up, whereby the maximum loading acting on the axial bearings is reduced.

Provision can be made that first and second bearing surfaces at least partly project radially beyond an outer periphery of the surface of the plate. In other words the bearing surfaces are arranged, in relation to the surface of the plate on which the workpieces to be machined are for example arranged, in a radially further outwardly disposed region in order to be able to offer as much bearing surface as possible which takes up the loading acting on the table. Tilting moments in particular can in this way also be efficiently taken up.

A constructionally simple design of the bearing arrangement results when the bearing surface and the radial bearing surface are arranged approximately perpendicular to one another. For example, the said surfaces can form a reclining “U”.

In accordance with one embodiment the radial bearing surface defines a maximum outer periphery of the plate. I.e. no other section of the plate has a larger radial spacing from the axis of rotation than the radial bearing surface. An exception to this could be components which have only a very subordinate significance with respect to the dynamics of the rotary movement of the plate such as, for example, a pointer element for the indication of an angle of rotation position of the rotary plate.

At least one of the bearing surfaces and/or the radial bearing surface can be formed at a guide section arranged on the plate. The guide section can project radially beyond an outer periphery of the surface of the plate so that maximum bearing radii can be realized.

The radial bearing can include rolling elements which stand directly in contact with the radial bearing surface and with a complementary radial bearing surface of the housing arranged at the housing. As an alternative, or in addition, provision can be made that the axial bearings include rolling elements which directly stand in contact with one of the bearing surfaces and with a complementary bearing surface of the housing arranged at the housing. In other words the housing and the plate itself form the bearing surfaces of the bearing arrangement so that the number of components can be reduced.

In order to improve the guiding of the rolling elements in the bearings corresponding guide grooves can be provided. In particular the radial bearing surface has a guide groove, in which the rolling elements of the radial bearing are at least partly arranged.

For the simplified assembly and/or servicing of the pivotal drive, provision can be made that at least one of the bearing surfaces of the housing and/or the radial bearing surface of the housing is or are formed at a bearing section releasably connected to the housing.

The plate can be of ring-shape, in order to be able to arrange installation tools/machining tools or other devices in the region of a central middle opening of the plate. In this way the plate is better accessible from radially outwardly and can be monitored more simply.

Basically the plate can also be directly driven to execute a rotary movement, for example by a torque motor. It is however also possible to attach to the plate a toothed ring which comes into engagement with a spur gear which can be driven by the motor. However, the plate preferably has a follower which engages into a drive groove of a barrel cam, with the plate being able to be driven to execute a rotary movement via the barrel cam, which can in turn be driven from the motor to execute a rotary movement about its longitudinal axis. A drive of this kind enables a precise rotary movement of the plate even with higher loading.

Further embodiments of the invention are set forth in the description, in the drawings and in the claims.

In the following the present invention will be explained purely by way of example with reference to an advantageous embodiment. There are shown:

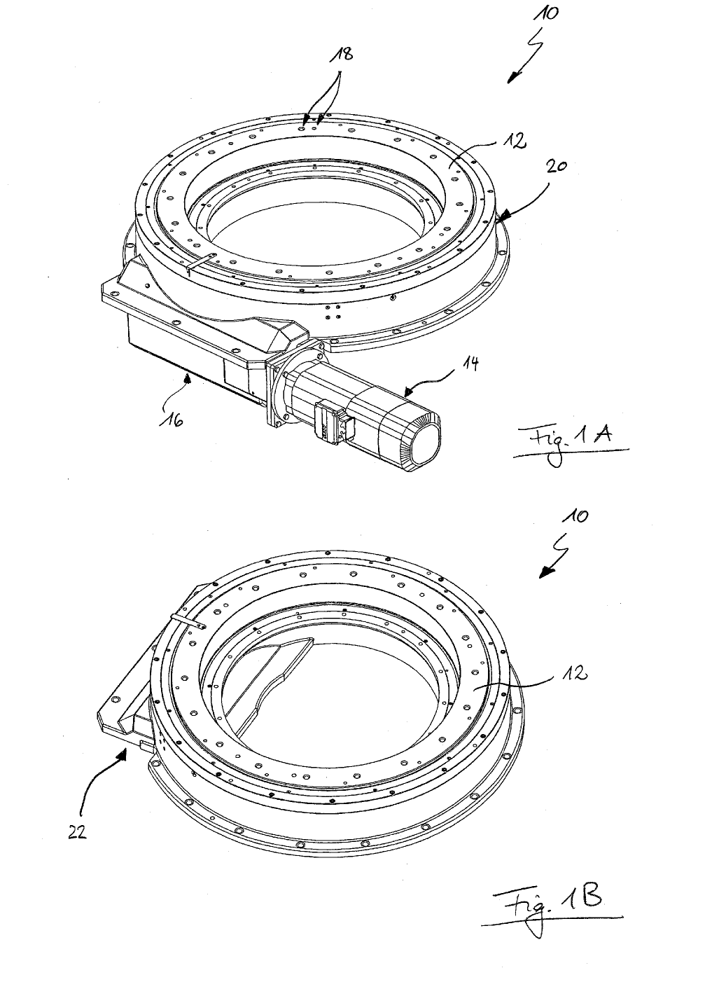

FIGS. 1A and 1B perspective views of an embodiment of the pivotal drive of the invention,

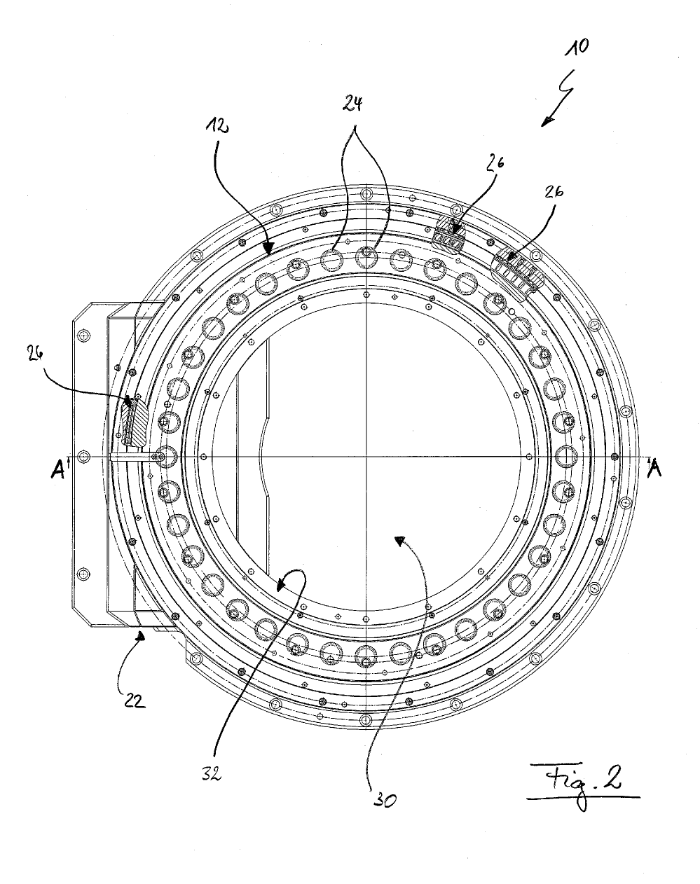

FIG. 2 a plan view of the pivotal drive of FIGS. 1A and 1B,

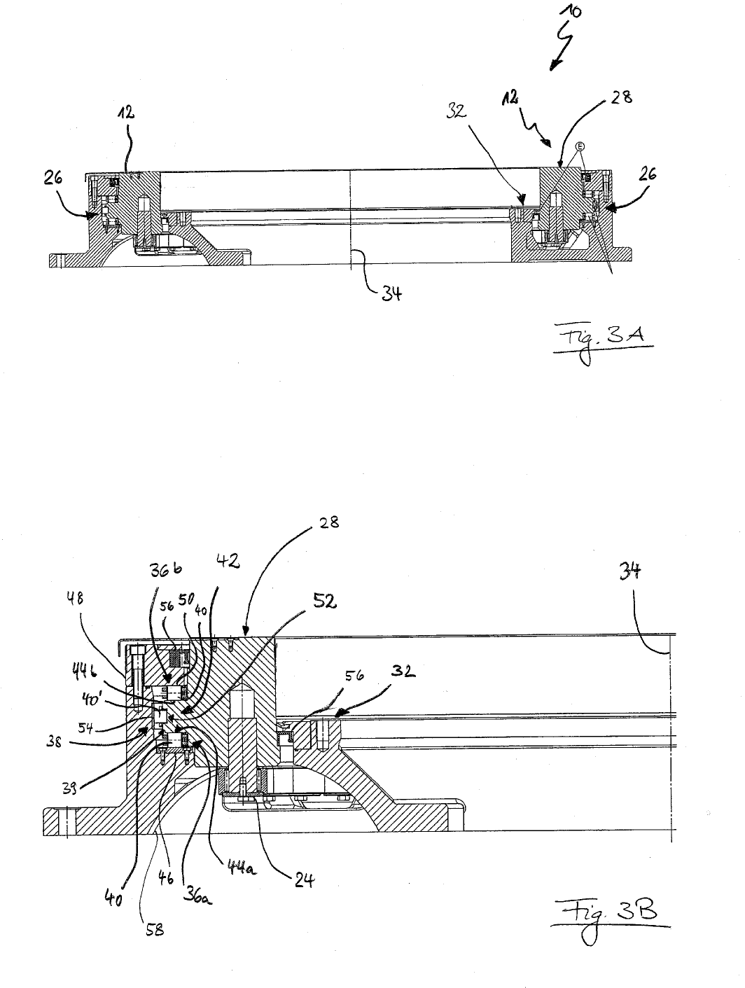

FIG. 3A a sectional view of the embodiment shown in FIGS. 1A, 1B and 2 of the pivotal drive of the invention,

FIG. 3B an enlarged section of FIG. 3A.

FIG. 1A shows a perspective view of a rotary indexing table 10 having a rotary plate 12 in the shape of a ring which can be driven to execute a rotary movement by a motor 14. A rotary drive movement of the motor 14 is transmitted in a suitable form via a transmission 16 which steps up or steps down the rotary movement in a suitable form and via a barrel cam, to be described in more detail in the following, to the rotary plate 12. At its surface the rotary plate 12 has bores 18 by means of which workpieces to be processed can for example be directly or indirectly secured to the rotary plate 12. The rotary plate 12 is journalled in a housing 20.

FIG. 1B shows the rotary indexing table 10 from a different perspective without the transmission 16 and the motor 14. The transmission 16 is secured to a flange-like section of a barrel cam housing 22 which forms a part of the housing 20 and which covers over the already named barrel cam drive.

FIG. 2 shows the rotary indexing table 10 in a plan view, with the rotary plate 12 being shown transparently in order to show the positioning of followers 24 at its underside, which are part of the barrel cam drive which will be explained in more detail in the following. Moreover, the housing 20 is shown transparent at three points whereby views are possible into the design of a bearing arrangement 26 journaling the rotary plate 12 in the housing 20. The design of the bearing arrangement 26 will be explained in the following with reference to a section view along the section plane AA. An enlargement of the left hand part of the sectional view of FIG. 3A shown in FIG. 3B.

FIG. 2 furthermore makes it clear that through the ring-like design of the rotary plate 12 a large central opening 30 is made available. As a result of its generous design this enables the arrangement of a plurality of devices in its interior which engage radially from the inside on workpieces arranged on a working surface 28 of a plate 12 in order to machine this. Such devices can for example be secured to a stationary support surface 32.

FIG. 3A makes the ring-like character of the rotary plate 12 clear in a cross-section. A horizontal extent of the working surface 28 is smaller than a vertical extent of a rotary plate 12 whereby a high stability of the rotary plate 12 is achieved.

In order to enable a rotary movement of a rotary plate 12 about an axis of rotation 34 the bearing arrangement 26 is arranged at a radially outer side of the rotary plate 12. In this way high loadings and bending or tilting moments can also be taken up. Moreover, constructional space in the region of the central opening 30 is kept free by the radially outward arrangement of the bearing arrangement 26.

As can be seen in FIG. 3B in enlarged form the bearing arrangement 26 includes two axial bearings 36a, 36b and a radial bearing 38. The axial bearing 36a includes rolling elements 40 which cooperate with a bearing surface 44a arranged at a guide flange 42. The guide flange 42 forms a section of the plate 12 arranged radially outermost. It stands away from the ring-like base body of the plate 12 in the manner of a projection and has an approximately rectangular cross-section.

At the housing side the rolling elements 40 cooperate with a bearing ring 46 which is bolted to the barrel cam housing 22—and thus to the housing 20. The axial bearing 36a takes up forces acting from the working surface from above. The rotary plate 12 thus lies on the guide flange 42 in the housing 20.

Forces acting in the opposite direction, which can for example occur with non-uniform loading of the rotary plate 12 are taken up by the axial bearing 36b which likewise includes rolling elements 40. A bearing surface 44b of the axial bearing 36b associated with the rotary plate 12 is formed at an opposite side of the guide flange 42 from the bearing surface 44a. At the housing side a ring surface 50 formed at a housing ring 48 forms a support for the rolling elements 40. The housing ring 48 is bolted to the housing 20.

In other words the guide flange 42 is journalled from two opposite sides by the axial bearings 36a, 36b so that tilting moments acting on the rotary table 12 can also be taken up reliably.

A radial journaling of the rotary plate 12 in the housing 20 is made available by the radial bearing 38. Rolling elements 40′ of the radial bearing 38 cooperate with a radially outer side of the guide flange 42. This forms a radial bearing surface 39. In order to improve the guidance of the rolling elements 40′ the radial bearing surface 39 has a guide groove 52. At the housing side the rolling elements 40′ roll of on a ring element 54 which is arranged at the housing 20 and at the housing 22 of the barrel cam. A reliable security of the rotary table 12 against shifts in a horizontal plane perpendicular to the rotary axis 34 is ensured through the radial journaling of the rotary plate 12 at a surface element disposed as far radially outwardly as possible.

The guide flange 42 is formed in one piece with the rotary plate 12. For particular requirements provision can however be made for it to be releasably secured to the rotary plate 12. The one-piece design increases the stiffness of the rotary plate 12 which is of significance for the precise positioning of the workpieces arranged on the working surface 28 of the rotary plate 12. The housing side components of the bearings 36a, 36b, 38 can be exchanged if required since they are—as described—releasably secured to the housing 20.

Shaft sealing rings 56 seal off the interior of the housing 20 for the protection of the bearings 36a, 36b, 38 and of the drive components of the rotary indexing table 10 in that they reliably close the intermediate spaces between the housing ring 48 and the rotary plate 12 and also between the rotary plate 12 and the housing components providing the support surface 32.

The driving of the rotary plate 12 takes place via a barrel cam 58 which has a drive groove. The already mentioned followers 24 engage into the drive groove. With a rotary movement of the barrel cam 58 a rotary movement of the rotary plate 12 about the axis of rotation 34 is generated by the drive groove—follower coupling.

### REFERENCE NUMERAL LIST

10 rotary indexing table

12 rotary plate

14 motor

16 transmission

18 bore

20 housing

22 barrel cam housing

24 follower

26 bearing arrangement

28 working surface

30 central opening

32 support surface

34 axis of rotation

36a, 36b axial bearing

38 radial bearing

39 radial bearing surface

40, 40′ rolling elements

42 guide flange

44a, 44b bearing surface

46 bearing ring

48 housing ring

50 ring surface

52 guide groove

54 ring element

56 shaft seal ring

58 barrel cam

AA section plane

1. A pivotal drive having a plate (12) which can be driven by a motor (14) to execute a rotary movement about an axis of rotation (34) and having a bearing arrangement (26) for the support of the plate (12) in a housing (20, 22) of the pivotal drive, the bearing arrangement including at least one radial bearing (38) and at least a first axial bearing (36a) and a second axial bearing (36b), with the radial bearing (38) cooperating with a radial bearing surface (39) formed by an outer peripheral surface of the plate (12), with the first axial bearing (36a) cooperating with a first axial bearing surface (44a) of the plate (12) and the second axial bearing (36b) cooperating with a second axial bearing surface (44b) of the plate (12), and wherein the axial bearing surfaces (44a, 44b) are arranged displaced parallel to one another with respect to the axis of rotation (34) of the plate (12).

2. A pivotal drive in accordance with claim 1, wherein
the axial bearing surfaces (44a, 44b) at least partly overlap when seen in the direction of the axis of rotation (34).

3. A pivotal drive in accordance with claim 1,
wherein the first axial bearing surface (44a) and the second axial bearing surface (44b) extend substantially perpendicular to the axis of rotation (34), with the first axial bearing surface (44a) facing away from a surface (28) of the plate (12) and with the second axial bearing surface (44b) facing towards the surface (28) of the plate (12).

4. A pivotal drive in accordance with claim 1, wherein the first and second axial bearing surfaces (44a, 44b) at least partly project radially beyond an outer periphery of a surface (28) of the plate (12).

5. A pivotal drive in accordance with claim 1, wherein the axial bearing surfaces (44a, 44b) and the radial bearing surface (39) are arranged at least approximately perpendicular to one another.

6. A pivotal drive in accordance with claim 1, wherein the radial bearing surface (39) defines a maximum outer periphery of the plate (12).

7. A pivotal drive in accordance with claim 1, wherein at least one of the axial bearing surfaces (44a, 44b) and/or the radial bearing surface (39) are formed at a guide section (42) arranged on the plate (12).

8. A pivotal drive in accordance with claim 7, wherein the guide section (42) projects radially beyond an outer periphery of the surface (28) of the plate (12).

9. A pivotal drive in accordance with claim 7, wherein the guide section (42) is formed as a flange in one piece with the plate (12).

10. A pivotal drive in accordance with claim 1, wherein the radial bearing (38) includes rolling elements (40′) which stand directly in contact with the radial bearing surface (39) and with a complementary radial surface (54) of the housing arranged at the housing.

11. A pivotal drive in accordance with claim 10, wherein the radial bearing surface (39) has a guide groove (52) in which the rolling elements (40′) of the radial bearing (38) are at least partly arranged.

12. A pivotal drive in accordance with claim 10 wherein at least one of the axial bearing surfaces of the housing and the radial bearing surface of the housing is formed at a bearing section (46, 50, 54) releasably connected to the housing (20, 22).

13. A pivotal drive in accordance with claim 1, wherein the plate (12) has the shape of a ring.

14. A pivotal drive in accordance with claim 1, wherein the plate (12) has a follower (24) engaging into a guide groove of a barrel cam, with the plate 12 being drivable to execute a rotary movement via the barrel cam (58), which can in turn be driven by a motor to execute a rotary movement about its longitudinal axis.

15. A pivotal drive in accordance with claim 1, said pivotal drive being an indexing table.

16. A pivotal drive in accordance with claim 15, said indexing table being a round indexing table.

17. A pivotal drive in accordance with claim 2, wherein the axial bearing surfaces (44a, 44b) overlap fully when seen in the direction of the axis of rotation (34).

18. A pivotal drive in accordance with claim 1, wherein the axial bearings (36a, 36b) including rolling elements (40) which stand directly in contact with one of the axial bearing surfaces (44a, 44b) and with a complementary bearing surfaces of the housing (46, 50) arranged at the housing.
